(19) United States
(12) Patent Application Publication
(10) Pub. No.: US 2006/0078272 A1
(43) Pub. Date: Apr. 13, 2006

(54) Audio-video playback system configured for simultaneously outputting different audio-video content to a plurality of output devices

(76) Inventor: Lillian Negoescu, Allentown, PA (US)

Correspondence Address: Raymond M. Galasso;Simon, Galasso & Frantz PLC, P.O. Box 26503, Austin, TX, 78755-0503, US

(21) Appl. No.: 10/960,145

(22) Filed: Oct. 7, 2004

(51) Int. Cl. H04N 5/781

(52) U.S. Cl. 386/46; 386/125

(57) ABSTRACT

An audio-video playback system comprises a first unit and a second unit. The first unit includes an audio-video content playback device and a playback controller connected to the audio-video playback device. The second unit includes a speaker, a video display and an audio-video signal interface. The playback controller enables selection of an audio-video content choice for playback by the audio-video content playback device. Playback by the audio-video content playback device includes generating an audio-video signal corresponding to the selected audio-video content choice. The audio-video interface is connected to the speaker, the video display and the first unit. The audio-video interface is configured for outputting an audio portion of the audio-video signal for reception by the speaker and a video portion of the audio-video signal for reception by the video display.

### FIELD OF THE DISCLOSURE

The disclosures made herein relate generally to audio and video playback systems and, more particularly, to systems configured for providing jukebox functionality.

### BACKGROUND

Present audio jukebox systems are configured for facilitating selective playback of recorded audio content (e.g., musical recordings). Such present audio jukebox systems are referred to herein as conventional jukebox systems. In one embodiment of conventional jukebox systems, such systems are standalone units that facilitate user interface, playback and audio output functionalities all via a single physical system whereby all patrons in a given area of an establishment (e.g., a restaurant) are served by a single jukebox unit. In another embodiment of conventional jukebox systems, user interface functionality is provided for at one or more remote user interface units of a conventional jukebox system that interface with a main unit of the conventional jukebox system. In such an embodiment, the main unit of the conventional jukebox system facilitates playback functionality as well as user interface and/or audio output functionalities. In still another embodiment of conventional jukebox systems, user interface and audio output functionalities are provided for at a plurality of remote user interface units of a conventional jukebox system that interface with a main unit of the conventional jukebox system. In such an embodiment, each one of the remote user interface units interfaces with the main unit and is configured for enabling different audio content to be selectively outputted at the respective remote location (e.g., by a respective speaker of a remote user interface unit). The main unit is configured for enabling simultaneous selection and playback of audio content remotely and, optionally, locally.

Such conventional jukebox systems are not configured for enabling playback of audio-video content. For example, they do not include means for outputting the video portion of audio-video content at a main unit and/or at remote user interface units. This limitation adversely affects their profitability, effectiveness, desirability and/or practicality. Therefore, a jukebox system that overcomes this limitation would be useful, advantageous and novel.

### SUMMARY OF THE DISCLOSURE

In one embodiment, an audio-video playback system comprises a first unit and a second unit. The first unit is configured for generating a first audio-video signal corresponding to a first selected audio-video content choice. The second unit is connected to the first unit and is configured for visually and audibly outputting the first audio-video signal. The first unit and/or the second unit are configured for enabling a user to select the first selected audio-video content choice from a plurality of available audio-video content choices.

In another embodiment, an audio-video playback system comprises a first unit and a second unit. The first unit includes an audio-video content playback device and a playback controller connected to the audio-video playback device. The second unit includes a speaker, a video display and an audio-video signal interface. The playback controller enables selection of an audio-video content choice for playback by the audio-video content playback device. Playback by the audio-video content playback device includes generating an audio-video signal corresponding to the selected audio-video content choice. The audio-video interface is connected to the speaker, the video display and the first unit. The audio-video interface is configured for outputting an audio portion of the audio-video signal for reception by the speaker and a video portion of the audio-video signal for reception by the video display.

In another embodiment, a method comprises receiving a first audio-video content choice selection at a first unit and accepting a first payment for enabling visual and audible output of a first audio-video signal corresponding to the first audio-video content choice selection by a second unit. In response to performing the accepting the first payment, the first audio-video signal corresponding to the first audio-video content choice selection is generated. The first unit performs generating the first audio-visual signal. The first audio-video signal is transmitted from the first unit for reception by the second unit in conjunction with generating the first audio-video signal being performed.

Correspondingly, it is a principal object of the inventive disclosures made herein to provide an audio-video playback system that overcomes drawbacks associated with conventional audio playback systems. Embodiments of systems and methods in accordance with the inventive disclosures made herein (e.g., an audio-video jukebox, a curriculum presentations system, etc) allow users (e.g., restaurant/bar patrons, students, etc) to experience a self-selected audio-video presentation (e.g., a music video, education/instructional coursework, etc) at their seat or table. Accordingly, such embodiments of systems and methods in accordance with the inventive disclosures made herein are advantageous in view of conventional audio playback systems such as jukeboxes.

Turning now to specific embodiments of the inventive disclosures made herein, in at least one embodiment of the inventive disclosures made herein, one or more units of an audio-video playback system is configured for accepting payment for enabling the visual and audible output corresponding to the first selected audio-video content choice.

In at least one embodiment of the inventive disclosures made herein, one or more units of an audio-video playback system is configured for presenting available audio-video content choices.

In at least one embodiment of the inventive disclosures made herein, one or more units of an audio-video playback system includes means for facilitating user interface functionality.

In at least one embodiment of the inventive disclosures made herein, one or more units of an audio-video playback system includes means for accepting payment for enabling the visual and audible output, means for presenting available audio-video content choices and/or means for facilitating selection of a desired one of the available audio-video content choices.

In at least one embodiment of the inventive disclosures made herein, one or more units of an audio-video playback system include storage media that includes data corresponding to the first selected audio-video content choice.

In at least one embodiment of the inventive disclosures made herein, generating an audio-video signal corresponding to a selected audio-video content choice includes accessing data maintained on storage media.

In at least one embodiment of the inventive disclosures made herein, a first unit of an audio-video playback system is configured for generating a plurality of audio-video signals corresponding to respective selected audio-video content choices.

In at least one embodiment of the inventive disclosures made herein, generating a first audio-video signal is performed at least partially concurrent with generating a second audio-video signal.

In at least one embodiment of the inventive disclosures made herein, a plurality of units are connected to a main unit and are configured for selectively and individually outputting respective audio-video content.

These and other objects and embodiments of the inventive disclosures made herein will become readily apparent upon further review of the following specification and associated drawings.

### BRIEF DESCRIPTION OF THE DRAWINGS

FIG. 1 depicts an embodiment of an overall arrangement for an audio-video playback system in accordance with the inventive disclosures made herein.

FIG. 2 depicts an embodiment of an overall system component structure for the audio-video playback system in accordance with the inventive disclosures made herein.

### DETAILED DESCRIPTION OF THE DRAWINGS

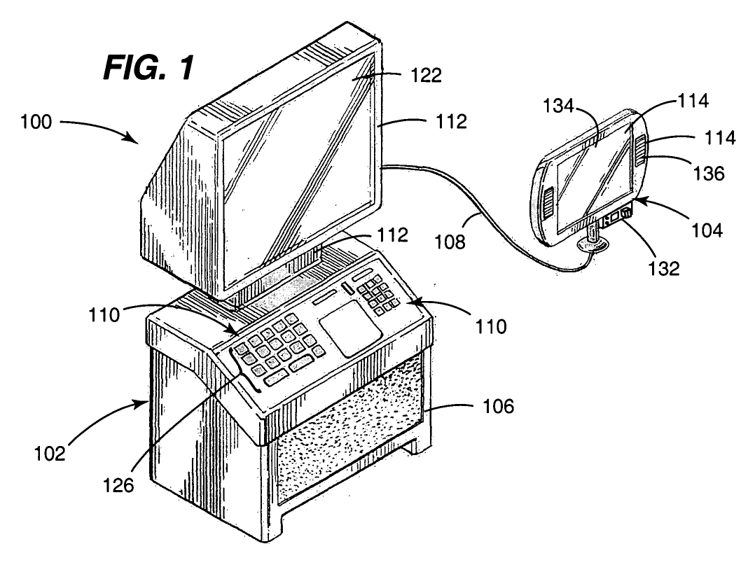

FIG. 1 depicts an embodiment of an overall arrangement for an audio-video playback system 100 in accordance with the inventive disclosures made herein. The audio-video playback system 100 includes a main unit 102 (i.e., a first unit) and a remote unit 104 (i.e., a second unit). The remote unit 104 is connected to a console 106 of the main unit 102 via an interconnect means 108 such as, for example, an interface cable. Such an interconnect means 108 enables interaction therebetween.

To facilitate user interface functionality (e.g., paying for and selecting audio-video content choices) in accordance with the inventive disclosures made herein, the main unit 102 includes a user interface 110 and audio-video output means 112 (e.g., respective video display and speaker) and, similarly, the remote unit 104 includes audio-video output means 114 (e.g., respective video display and speaker). In at least one embodiment, system components configured for carrying out audio-video playback functionality in accordance with the inventive disclosures made herein (discussed in greater detail below) are preferably housed in the console 106. Examples of such audio-video playback functionality include accessing and processing data corresponding to selected audio-video content choices, generating signals corresponding to such audio-video content data and audibly and/or visually outputting such signals. The audio-video content is comprised by data that is stored on one or more forms of storage means (e.g., optical storage means, semiconductor storage means, magnetic storage means, etc). Accordingly, the depicted arrangement provides for audio-video content maintained and/or processed at the console 106 (i.e., at the main unit 102) to be selected, paid for and/or displayed at the main unit 102 and/or the remote unit 104.

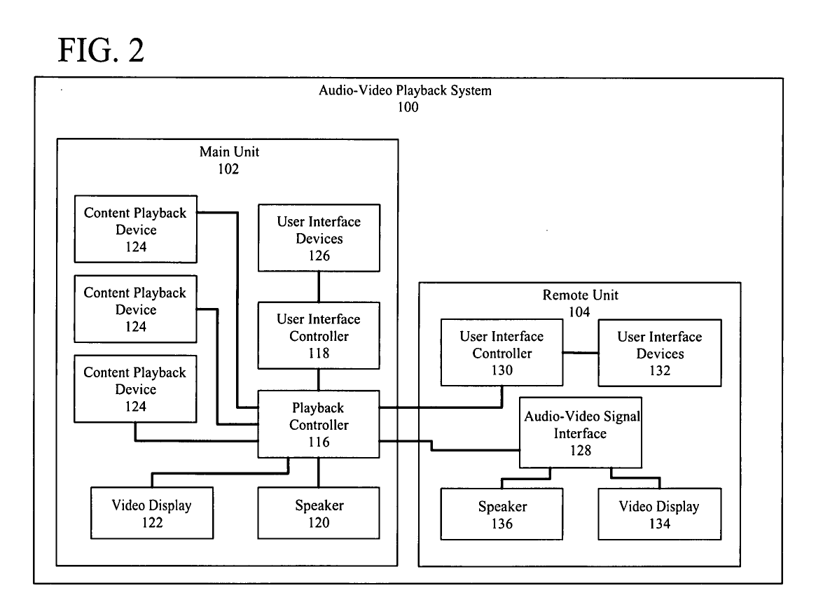

Referring now to FIGS. 1 and 2, the remote unit 104 is located at a relative distance from the main unit 102. In one example, the main unit 102 is located in a first area of a premise (e.g., in a bar area of a restaurant) and the remote unit 104 is located at a booth in a dining area of the restaurant. Preferably, in other embodiments, the audio-video playback system 100 includes a plurality of additional remote units (e.g., positioned at respective booths in the dining areas of the restaurant).

The main unit 102 includes a playback controller 116, a user interface controller 118, a speaker 120, a video display 122, a plurality of content playback devices 124 and a plurality of user interface devices 126. The playback controller 116 is connected through a suitable interface or interfaces to the user interface controller 118, speaker 120, the video display 122, and the plurality of content playback devices 124 for enabling interaction therebetween. The user interface controller 118 is connected through a suitable interface or interfaces to the plurality user interface devices 126. Each one of the content playback units 124 has access to a respective collection and/or universal collection of audio video content media (e.g., digital video discs, laser discs, video cassettes, digital video storage files, etc).

The playback controller 116 is configured for integrating and/or managing functionality and/or signals of the user interface controller 118, the speaker 120, the video display 122, the plurality of content playback devices 124 and/or the plurality of user interface devices 126. The user interface controller 118 is configured for integrating and/or managing user interface functionality and/or signals of the plurality of user interface devices 126. Examples of such user interface functionality includes accepting payment for enabling visual and audible output of audio-video content, presenting available audio-video content choices and facilitating selection of a desired one of the available audio-video content choices. For example, in response to the user interface devices 126 and user interface controller 118 facilitating selection and payment for a desired audio-video content choice, the playback controller 116 facilitates accessing of data corresponding to the selected audio-video content choice, generating a corresponding signal, and providing that signal to the appropriate output devices of the main unit 102 and/or the remote unit 104.

A card reader (e.g., for accepting payment), a bill changer (e.g., for accepting payment), a display screen (e.g., for facilitating content choice selection), a keypad (e.g., for facilitating content choice selection) and the like are examples of the user interface devices 126 of the main unit. Drive units configured for reading data from storage means such as, for example, optical storage means, semiconductor storage means or magnetic storage means are examples of the content playback devices 124. Specific examples of media and/or storage drive formats include digital video disc (DVD), laser disc (LD), video cassette recorder (VCR) and digital video recorder (DVR).

The remote unit 104 includes an audio-video signal interface 128, a user interface controller 130, a plurality of user interface devices 132, a video display 134 and a speaker 134. The user interface devices 132 are connected to the user interface controller 130 for facilitating and/or enabling user interface functionality such as accepting payment for enabling visual and audible output of audio-video content, presenting available audio-video content choices and facilitating selection of a desired one of the available audio-video content choices. The video display 134 and the speaker 136 are connected to the audio-video signal interface 128. The user interface controller 130 and the audio-video signal interface 128 are connected to the main unit 102 through the playback controller 116. The audio-video interface 128 is configured for enabling output of audio and video portions of the signal generated and/or managed by the playback controller 116 to the video display 134 and the speaker 136. The user interface controller 130 is configured for integrating and/or managing functionality and/or signals of the plurality of user interface devices 132 and for facilitating appropriate interaction with the main unit 102.

In one specific embodiment (not specifically shown) of the inventive disclosures made herein, an audio-video playback system includes a main unit (e.g., the main unit 102) and a plurality of remote units (e.g., configured similarly as remote unit 104). Each one of the remote units is connected to the main unit and is configured for visually and audibly outputting respective audio-video signals generated by the main unit. The main unit and/or the remote units are configured for enabling users to select a respective audio-video content choice from a plurality of available audio-video content choices. In this specific embodiment, the main unit is configured for generating a first audio-video signal corresponding to an audio-video content choice selected for presentation at a first one of the remote units and for generating a second audio-video signal corresponding to an audio-video content choice selected for presentation at a second one of the remote units. For facilitating presentation of the first and second audio-video content choices, the main unit is configured for generating and/or providing the first audio-video signal at least partially concurrent with generating and/or providing the second audio-video signal. In this manner, the first and the second audio-video content choices can be presented at least partially concurrent with each other via respective remote units.

In the preceding detailed description, reference has-been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An audio-video playback system, comprising:
a first unit configured for generating a first audio-video signal corresponding to a first selected audio-video content choice;
a second unit connected to the first unit and configured for visually and audibly outputting the first audio-video signal;
wherein at least one of the first unit and the second unit is configured for:
enabling a user to select the first selected audio-video content choice from a plurality of available audio-video content choices.

2. The system of claim 1 wherein at least one of the first unit and the second unit is configured for accepting payment for enabling said visual and audible output corresponding to the first selected audio-video content choice.

3. The system of claim 1 wherein at least one of the first unit and the second unit is configured for presenting available audio-video content choices.

4. The system of claim 1 wherein:
at least one of the first unit and the second unit includes means for facilitating user interface functionality; and
said user interface functionality includes means for accepting payment for enabling said visual and audible output, means for presenting available audio-video content choices and means for facilitating selection of a desired one of said available audio-video content choices.

5. The system of claim 1 wherein:
the first unit includes storage media;
the storage media includes data corresponding to the first selected audio-video content choice; and
generating the first audio-video signal includes accessing said data.

6. The system of claim 1 wherein:
at least one of the first unit and the second unit is configured for accepting payment for enabling said visual and audible output;
at least one of the first unit and the second unit is configured for presenting available audio-video content choices;
at least one of the first unit and the second unit includes means for facilitating user interface functionality;
said user interface functionality includes means for accepting payment for enabling said visual and audible output, means for presenting available audio-video content choices and means for facilitating selection of a desired one of said available audio-video content choices;
the first unit includes storage media;
the storage media includes data corresponding to the first selected audio-video content choice; and
generating the first audio-video signal includes accessing said data.

7. The system of claim 1:
wherein the first unit is configured for generating a second audio-video signal corresponding to a second selected audio-video content choice and generating the first audio-video signal is performed at least partially concurrent with said generating the second audio-video signal; and
further comprising a third unit connected to the first unit and configured for visually and audibly outputting the second audio-video signal.

8. An audio-video playback system, comprising:
a first unit including an audio-video content playback device and a playback controller connected to the audio-video playback device, wherein the playback controller enables selection of an audio-video content choice for playback by the audio-video content playback device and wherein said playback by the audio-video content playback device includes generating an audio-video signal corresponding to said selected audio-video content choice;
a second unit including a speaker, a video display and an audio-video signal interface, wherein the audio-video interface is connected to the speaker, the video display and the first unit and is configured for outputting an audio portion of the audio-video signal for reception by the speaker and a video portion of the audio-video signal for reception by the video display.

9. The system of claim 8 wherein at least one of the first unit and the second unit is configured for accepting payment for enabling said visual and audible output.

10. The system of claim 8 wherein at least one of the first unit and the second unit is configured for presenting available audio-video content choices.

11. The system of claim 8 wherein:
at least one of the first unit and the second unit includes means for facilitating user interface functionality; and
said user interface functionality includes means for accepting payment for enabling said visual and audible output, means for presenting available audio-video content choices and means for facilitating selection of a desired one of said available audio-video content choices.

12. The system of claim 8 wherein:
the first unit includes storage media;
the storage media includes data corresponding to said selected audio-video content choice; and
generating the audio-video signal includes accessing said data.

13. The system of claim 8 wherein:
at least one of the first unit and the second unit is configured for accepting payment for enabling said visual and audible output;
at least one of the first unit and the second unit is configured for presenting available audio-video content choices;
at least one of the first unit and the second unit includes means for facilitating user interface functionality;
said user interface functionality includes means for accepting payment for enabling said visual and audible output, means for presenting available audio-video content choices and means for facilitating selection of a desired one of said available audio-video content choices;
the first unit includes storage media;
the storage media includes data corresponding to the selected audio-video content choice; and
generating the audio-video signal includes accessing said data.

14. A method, comprising:
receiving a first audio-video content choice selection at a first unit;
accepting a first payment for enabling visual and audible output of a first audio-video signal corresponding to the first audio-video content choice selection by a second unit;
generating the first audio-video signal corresponding to the first audio-video content choice selection in response to performing said accepting the first payment, wherein said generating the first audio-visual signal is performed by the first unit; and
transmitting the first audio-video signal from the first unit for reception by the second unit in conjunction with performing said generating the first audio-video signal.

15. The method of claim 14, further comprising:
presenting available audio-video content choices; and
enabling selection of said available audio-video content choices;
wherein said presenting is performed by at least one of the first unit and the second unit.

16. The method of claim 14 wherein said accepting the first payment is performed by at least one of the first unit and the second unit.

17. The method of claim 14 wherein:
generating the first audio-video signal includes accessing first data from storage media of the first unit; and
said first data corresponds to the audio-video content choice selection.

18. The method of claim 14, further comprising:
presenting available audio-video content choices; and
enabling selection of said available audio-video content choices;
wherein said presenting is performed by at least one of the first unit and the second unit;
wherein said accepting the first payment is performed by at least one of the first unit and the second unit;
wherein generating the first audio-video signal includes accessing first data from storage media of the first unit; and
wherein said first data corresponds to the first audio-video content choice selection.

19. The method of claim 1, further comprising:
receiving a second audio-video content choice selection at the first unit;
accepting a second payment for enabling visual and audible output of a second audio-video signal corresponding to the second audio-video content choice selection by a third unit;
generating the second audio-video signal corresponding to the second audio-video content choice selection in response to performing said accepting the second payment, wherein said generating the second audio-visual signal is performed by the first unit; and
transmitting the second audio-video signal from the first unit for reception by the third unit in conjunction with performing said generating the second audio-video signal.

20. The method of claim 19 wherein said transmitting the first audio-video signal is performed at least partially concurrent with said transmitting the second audio-video signal.
